(19) United States
(12) Patent Application Publication
(10) Pub. No.: US 2015/0263370 A1
(43) Pub. Date: Sep. 17, 2015

(54) MANUFACTURING METHOD AND MANUFACTURING APPARATUS OF REINFORCEMENT ELECTROLYTE MEMBRANE

(71) Applicant: TOYOTA JIDOSHA KABUSHIKI KAISHA, Toyota-shi (JP)

(72) Inventor: Shinya TAKESHITA, Toyota-shi (JP)

(73) Assignee: TOYOTA JIDOSHA KABUSHIKI KAISHA, Toyota-shi (JP)

(21) Appl. No.: 14/658,332

(22) Filed: Mar. 16, 2015

(30) Foreign Application Priority Data
Mar. 17, 2014 (JP) 2014-053121

(51) Int. Cl. H01M 8/10; B32B 37/00; B32B 37/18

(52) U.S. Cl. CPC H01M 8/1093; H01M 8/1039; H01M 8/1053; B32B 37/18; B32B 37/0046; H01M 2008/1095; B32B 2307/202; B32B 2457/18

(57) ABSTRACT

A manufacturing method of a reinforced electrolyte membrane includes: conveying a belt-shaped electrolyte membrane material including a back sheet on one surface thereof; and placing a belt-shaped reinforcing member on that surface of the electrolyte membrane material which is an opposite side to the back sheet so as to attach the electrolyte membrane material to the reinforcing member.

### INCORPORATION BY REFERENCE

The disclosure of Japanese Patent Application No. 2014-053121 filed on Mar. 17, 2014 including the specification, drawings and abstract is incorporated herein by reference in its entirety.

### BACKGROUND OF THE INVENTION

1. Field of the Invention

The present invention relates to a manufacturing method and a manufacturing apparatus of a reinforced electrolyte membrane.

2. Description of Related Art

Japanese Patent Application Publication No. 2008-4344 (JP 2008-4344 A) describes a manufacturing method of an electrolyte membrane of a fuel cell. In the manufacturing method, electrolyte resin melted by heating is extruded from a resin outlet of a die, and a porous reinforced membrane is supplied into the molten electrolyte resin thus extruded. Further, such a manufacturing method of an electrolyte membrane of a fuel cell is described that: a porous reinforced membrane supplied by two heated revolving rolls placed so as to be opposed to each other is buried in molten electrolyte resin, so that the porous reinforced membrane is impregnated with the molten electrolyte resin to firm a reinforced electrolyte membrane.

In the above technique, if the reinforced membrane is not supported by a back sheet, neck-in in which a width of the reinforced membrane is narrowed due to pulling of a reinforced layer might be caused.

### SUMMARY OF THE INVENTION

The present invention provides a manufacturing method and a manufacturing apparatus of a reinforced electrolyte membrane.

One aspect of the present invention relates to a manufacturing method of a reinforced electrolyte membrane. The manufacturing method includes: conveying a belt-shaped electrolyte membrane material including a back sheet on one surface thereof; and placing a belt-shaped reinforcing member on that surface of the electrolyte membrane material which is an opposite side to the back sheet so as to attach the electrolyte membrane material to the reinforcing member. In the manufacturing method of the present aspect, the electrolyte membrane material and the reinforcing member can be conveyed in a state where the belt-shaped electrolyte membrane material including the back sheet functions as a back sheet for the reinforcing member. Accordingly, neck-in of the reinforcing member can be restrained. Further, a back sheet for the reinforcing member is not required.

The manufacturing method according to the above aspect may further include winding up the electrolyte membrane material to which the reinforcing member is attached. Adhesion between the reinforcing member and the back sheet may be smaller than adhesion between the back sheet and the electrolyte membrane material, and adhesion between the reinforcing member and the electrolyte membrane material. According to the manufacturing method of the present aspect, when the electrolyte membrane material to which the reinforcing member is attached is send out (fed out), it is possible to restrain the back sheet from peeling off from the electrolyte membrane material or the reinforcing member from peeling off from the electrolyte membrane material.

In the manufacturing method according to the above aspect, the electrolyte membrane material may be made of a perfluoroalkyl sulfonic acid precursor, the back sheet may be made of perfluoroalkoxy alkane, and the reinforcing member may be made of stretched polytetrafluoroethylene. According to the manufacturing method of the present aspect, the adhesion between the reinforcing member and the back sheet can be made smaller than the adhesion between the back sheet and the electrolyte membrane material, and the adhesion between the reinforcing member and the electrolyte membrane material.

Another aspect of the present invention relates to a manufacturing apparatus of a reinforced electrolyte membrane. The manufacturing apparatus includes: an electrolyte-membrane manufacturing apparatus configured to manufacture a belt-shaped electrolyte membrane material including a back sheet on one surface thereof; and a reinforcing-member manufacturing apparatus configured to place a belt-shaped reinforcing member on the other surface of the belt-shaped electrolyte membrane material including the back sheet which other surface is an opposite side to the back sheet, so as to attach the reinforcing member to the electrolyte membrane material. According to the manufacturing apparatus of the present aspect, the belt-shaped electrolyte membrane material including the back sheet can be conveyed in a state where the belt-shaped electrolyte membrane material functions as a back sheet for the reinforcing member, thereby making it possible to restrain neck-in of the back sheet. Further, a back sheet for the reinforcing member is not required.

Note that the present invention can be realized in various aspects. For example, other than the manufacturing method of the reinforced electrolyte membrane, the present invention can be realized in the form of the manufacturing apparatus of the reinforced electrolyte membrane, and the like.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an explanatory view illustrating a manufacturing process of a reinforced electrolyte membrane, according to a first embodiment of the present invention;

FIG. 2 is an explanatory view illustrating a manufacturing process of a reinforced electrolyte membrane, according to a comparative example;

FIG. 3 is an explanatory view illustrating a manufacturing apparatus of a reinforced electrolyte membrane, according to a second embodiment of the present invention; and

FIG. 4 is an explanatory view illustrating feeding of the reinforced electrolyte membrane from a wind roll.

### DETAILED DESCRIPTION OF EMBODIMENTS

### First Embodiment

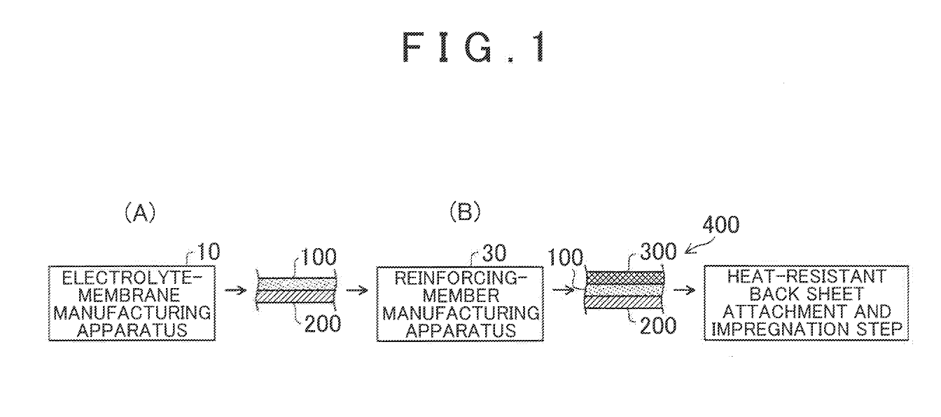

FIG. 1 is an explanatory view illustrating a manufacturing process of a reinforced electrolyte membrane, according to a first embodiment. The manufacturing process of the reinforced electrolyte membrane includes: (A) a step of manufacturing a belt-shaped electrolyte membrane material 100 including a back sheet 200; and (B) a step of manufacturing a reinforcing member 300 and placing the reinforcing member 300 on the electrolyte membrane material 100 so as to be attached thereto.

### (A) Step of Manufacturing Belt-shaped Electrolyte Membrane Material 100 Including Back Sheet 200

An electrolyte-membrane manufacturing apparatus 10 forms a belt-shaped electrolyte membrane material 100 on a belt-shaped back sheet 200. The back sheet 200 is made of perfluoroalkoxy alkane (PFA). In the first embodiment, as a material of the electrolyte membrane material 100, a perfluoroalkyl sulfonic acid precursor made by DOW Chemical Company is used. The electrolyte-membrane manufacturing apparatus 10 forms the belt-shaped electrolyte membrane material 100 on the back sheet 200 by applying the perfluoroalkyl sulfonic acid precursor on the back sheet 200. Hereby, the belt-shaped electrolyte membrane material 100 including the back sheet 200 on one surface thereof can be formed. The precursor indicates an electrolyte material before proton conductivity is given thereto by a hydrolysis treatment.

(B) Step of Manufacturing Reinforcing Member 300 and Placing Reinforcing Member 300 on Electrolyte Membrane Material 100 so as to be Attached thereto

A reinforcing-member manufacturing apparatus 30 manufactures a reinforcing member 300, and places the reinforcing member 300 on a surface of the electrolyte membrane material 100 including the back sheet 200 which surface is an opposite side to the back sheet 200. In the present embodiment, as the reinforcing member 300, a member obtained by stretching polytetrafluoroethylene (PTEF) is used. The reinforcing-member manufacturing apparatus 30 stretches a film of polytetrafluoroethylene in a belt shape, and places the film directly on the electrolyte membrane material 100 so as to attach the film thereto. Hereby, a reinforced electrolyte membrane 400 is manufactured. Note that the electrolyte membrane material 100 and the reinforcing member 300 are made of materials that allow the electrolyte membrane material 100 and the reinforcing member 300 to be attached to each other without an adhesive.

After that, the reinforced electrolyte membrane 400 is sent to an after process. In the after process, an impregnation step of attaching a heat-resistant back sheet to the reinforced electrolyte membrane 400 and impregnating the reinforcing member 300 with the electrolyte membrane material 100 is performed. The impregnation step may be performed by melt impregnation molding in which the reinforcing member 300 is impregnated with the electrolyte membrane material 100 by hot-press.

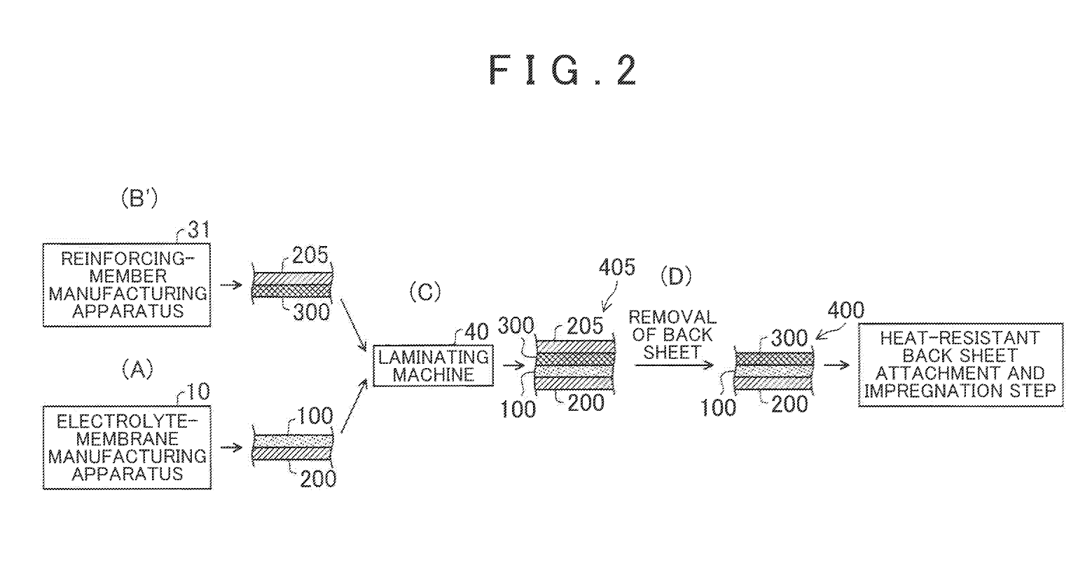

FIG. 2 is an explanatory view illustrating a manufacturing process of a reinforced electrolyte membrane, according to a comparative example. The manufacturing process of a reinforced electrolyte membrane, according to the comparative example, includes: (A) a step of manufacturing a belt-shaped electrolyte membrane material 100 including a back sheet 200; (B′) a step of manufacturing a reinforcing member 300 and attaching it to a reinforcing-member back sheet 205; (C) a step of laminating the belt-shaped electrolyte membrane material 100 including the back sheet 200 and the reinforcing member 300 to which the reinforcing-member back sheet 205 is attached; and (D) a step of peeling off the reinforcing-member back sheet 205.

(A) Step of Manufacturing Belt-shaped Electrolyte Membrane Material 100 Including Back Sheet 200

This step is the same as the step of manufacturing a belt-shaped electrolyte membrane material 100 including a back sheet 200, as described in the present embodiment, so that descriptions thereof are omitted.

(B) Step of Manufacturing Reinforcing Member 300 and Attaching It to Reinforcing-Member Back Sheet 205

A reinforcing-member manufacturing apparatus 31 manufactures a reinforcing member 300 including a reinforcing-member back sheet 205 by stretching a film of polytetrafluoroethylene and attaching it to the reinforcing-member back sheet 205. The reinforcing-member back sheet 205 is used to restrain neck-in of the reinforcing member 300. When the member is conveyed or wound up, the member is pulled in a conveying direction or a winding direction. The neck-in indicates that, when the member is pulled, the member is deformed to be thin in a direction intersecting with a pulling direction.

(C) Step of Laminating Belt-shaped Electrolyte Membrane Material 100 Including Back Sheet 200 and Reinforcing Member 300 to which Reinforcing-Member Back Sheet 205 is Attached

A laminating machine 40 forms a laminated body 405 by laminating the reinforcing member 300 to which the reinforcing-member back sheet 205 is attached, on the belt-shaped electrolyte membrane material 100 including the back sheet 200, so that the reinforcing member 300 is disposed on the electrolyte membrane material 100.

### (D) Step of Peeling off Reinforcing-Member Back Sheet 205

In this step, the reinforcing-member back sheet 205 is peeled off from the laminated body 405, so as to form a reinforced electrolyte membrane 400. Note that, its subsequent step, i.e., an impregnation step of attaching a heat-resistant back sheet to the reinforced electrolyte membrane 400 and impregnating the reinforcing member 300 with the electrolyte membrane material 100 is the same as the first embodiment, so that descriptions thereof are omitted.

The first embodiment is compared with the comparative example as follows. In the comparative example, since the reinforcing member 300 is attached to the reinforcing-member back sheet 205, the reinforcing-member back sheet 205 is required. In contrast, in the first embodiment, since the belt-shaped electrolyte membrane material 100 including the back sheet 200 functions as a back sheet for a reinforcing member, the reinforcing-member back sheet 205 as another member is unnecessary. As a result, a reduction in manufacturing cost and resource saving can be realized. Further, in the first embodiment, since the belt-shaped electrolyte membrane material 100 including the back sheet 200 functions as a back sheet for a reinforcing member, neck-in of the reinforcing member 300 can he restrained.

In the first embodiment, perfluoroalkoxy alkane is used as a material of the back sheet 200, but polypropylene, PET (polyethylene terephthalate)), or LDPE (low density polyethylene) may be used.

In the first embodiment, stretched polytetrafluoroethylene is used as a material of the reinforcing member, but a film formed by stretching other porous polymer resins such as polyethylene (PE), polypropylene (PP), and polyimide may be used.

In the first embodiment, as a material of the electrolyte membrane material 100, a perfluoroalkyl sulfonic acid precursor made by DOW Chemical Company is used. However, the electrolyte membrane material 100 may be made of perfluorosulfonic acid polymer such as Nafion (registered trademark).

### Second Embodiment

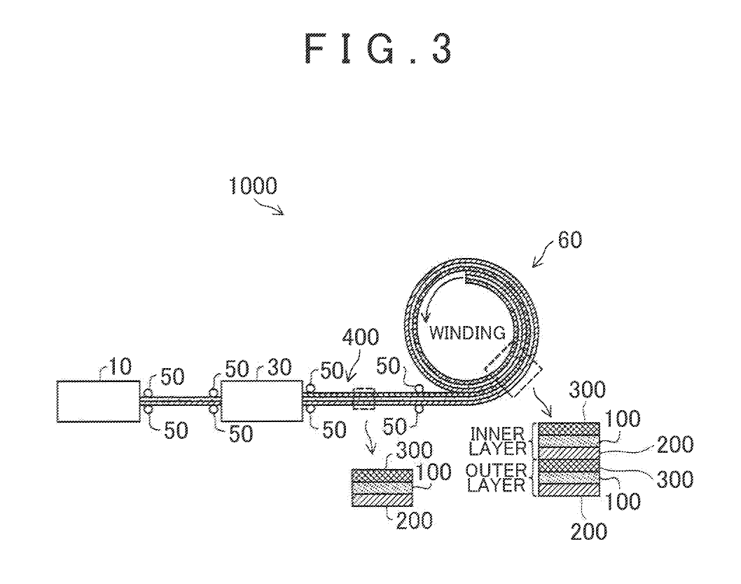

FIG. 3 is an explanatory view illustrating a manufacturing apparatus 1000 of a reinforced electrolyte membrane, according to a second embodiment. In the first embodiment, after the reinforced electrolyte membrane 400 is manufactured, the impregnation step (after process) of attaching the heat-resistant back sheet thereto and impregnating the reinforcing member 300 with the electrolyte membrane material 100 is performed. However, the second embodiment is different from the first embodiment in that, after a reinforced electrolyte membrane 400 is manufactured, the reinforced electrolyte membrane 400 thus manufactured is wound up by a wind roll 60, and when an after process is performed, the reinforced electrolyte membrane 400 is send out (fed out) from the wind roll 60. Note that FIG. 1 shows the process as a manufacturing process, but FIG. 3 shows the process as the manufacturing apparatus 1000. The manufacturing apparatus 1000 of a reinforced electrolyte membrane includes an electrolyte-membrane manufacturing apparatus 10, a reinforcing-member manufacturing apparatus 30, a conveying apparatus 50, and the wind roll 60.

The electrolyte-membrane manufacturing apparatus 10 applies a perfluoroalkyl sulfonic acid precursor to a back sheet 200 made of perfluoroalkoxy alkane, so as to form a belt-shaped electrolyte membrane material 100 including the back sheet 200. In the present embodiment, as the perfluoroalkyl sulfonic acid precursor, a perfluoroalkyl sulfonic acid precursor made by DOW Chemical Company (DOW type, EW650, MI20) is used. Here, “DOW” is a registered trademark, Further, “EW” indicates a dry weight (gram) of the perfluoroalkyl sulfonic acid precursor per one mol of sulfonic acid. Further, “MI” indicates a melt index (also referred to as a melt flow rate). The melt index is obtained such that a given amount of resin is heated and pressurized at a predetermined temperature in a cylindrical container heated by a heater, and an amount of the resin extruded, in ten minutes, from an opening (a nozzle) provided in a bottom of the container is measured. Note that a unit of the melt index is g/10 min.

The reinforcing-member manufacturing apparatus 30 stretches a film of polytetrafluoroethylene in a belt shape, and places the film on that surface of the electrolyte membrane material 100 which is opposite to the back sheet 200. The conveying apparatus 50 conveys the belt-shaped electrolyte membrane material 100 including the back sheet 200, and a reinforced electrolyte membrane 400. As the conveying apparatus 50, rollers are used. The wind roll 60 winds up the reinforced electrolyte membrane 400. As illustrated in FIG. 3, each of an inner layer and outer layer of the reinforced electrolyte membrane 400 includes a reinforcing member 300, the electrolyte membrane material 100, the back sheet 200, which are disposed in this order from an inner side, and the reinforcing member 300 of the outer layer is provided outside the back sheet 200 of the inner layer. Note that the inner layer is connected to the outer layer. However, a plurality of layers seem to overlap with each other in a radial direction of the wind roll 60, so they are described with the terms “inner layer” and “outer layer” for convenience.

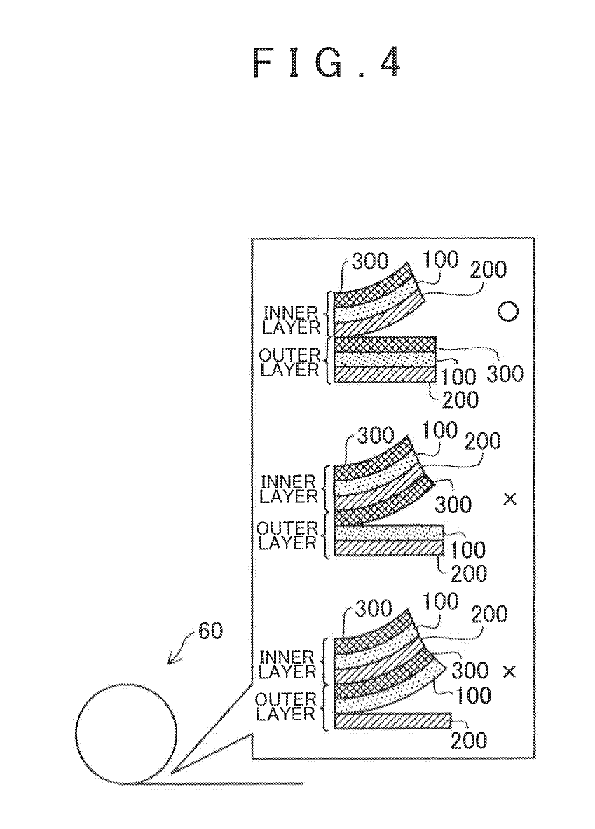

FIG. 4 is an explanatory view illustrating feeding of the reinforced electrolyte membrane 400 from the wind roll 60. The wind roll 60 sends out (feeds out) the reinforced electrolyte membrane 400. At this time, adhesion between the reinforcing member 300 and the back sheet 200 is smaller than adhesion between the back sheet 200 and the electrolyte membrane material 100, and adhesion between the reinforcing member 300 and the electrolyte membrane material 100. Hereby, when the reinforced electrolyte membrane 400 is sent out, the reinforcing member 300 is peeled off from the back sheet 200, and the reinforced electrolyte membrane 400 including one back sheet 200, one electrolyte membrane material 100, and one reinforcing member 300 is sent out.

Note that, in a case where the adhesion between the reinforcing member 300 and the back sheet 200 is larger than the adhesion between the back sheet 200 and the electrolyte membrane material 100, or the adhesion between the reinforcing member 300 and the electrolyte membrane material 100, the back sheet 200 is peeled off from the electrolyte membrane material 100, so that only the back sheet 200 is sent out, or the reinforcing member 300 is peeled off from the electrolyte membrane material 100, so that only two layers of the electrolyte membrane material 100 and the back sheet 200 are sent out.

In the second embodiment, the perfluoroalkyl sulfonic acid precursor (DOW type, EW650, MI20) is employed as a material of the electrolyte membrane material 100, perfluoroalkoxy alkane is employed as a material of the back sheet 200, and stretched polytetrafluoroethylene is employed as a material of the reinforcing member 300. This allows the adhesion between the reinforcing member 300 and the back sheet 200 to be smaller than the adhesion between the back sheet 200 and the electrolyte membrane material 100, and the adhesion between the reinforcing member 300 and the electrolyte membrane material 100. Consequently, the reinforced electrolyte membrane 400 including one back sheet 200, one electrolyte membrane material 100, and one reinforcing member 300 can be sent out from the wind roll 60.

In the second embodiment, the perfluoroalkyl sulfonic acid precursor (DOW type, EW650, MI20) is employed as the material of the electrolyte membrane material 100, perfluoroalkoxy alkane is employed as the material of the back sheet 200, and stretched polytetrafluoroethylene is employed as the material of the reinforcing member 300. However, if the adhesion between the reinforcing member 300 and the back sheet 200 is smaller than the adhesion between the back sheet 200 and the electrolyte membrane material 100, and the adhesion between the reinforcing member 300 and the electrolyte membrane material 100, it is possible to send out, from the wind roll 60, the reinforced electrolyte membrane 400 including one back sheet 200, one electrolyte membrane material 100, and one reinforcing member 300. In view of this, a material other than the perfluoroalkyl sulfonic acid precursor can be employed as the material of the electrolyte membrane material 100, a material other than perfluoroalkoxy alkane can be used as the material of the back sheet 200, and a material other than stretched polytetrafluoroethylene can be employed as the material of the reinforcing member 300.

The embodiments of the present invention have been described above based on some examples, but the above embodiments of the present invention are intended to facilitate understanding of the present invention, and not to limit the present invention. The present invention can be altered or modified without departing from the gist and the scope of claims, and further, it is needless to say that the present invention includes its equivalent.

What is claimed is:

1. A manufacturing method of a reinforced electrolyte membrane, the manufacturing method comprising:
conveying a belt-shaped electrolyte membrane material including a back sheet on one surface thereof; and
placing a belt-shaped reinforcing member on that surface of the electrolyte membrane material which is an opposite side to the hack sheet so as to attach the electrolyte membrane material to the reinforcing member.

2. The manufacturing method of the reinforced electrolyte membrane, according to claim 1, further comprising:
winding up the electrolyte membrane material to which the reinforcing member is attached, wherein
adhesion between the reinforcing member and the back sheet is smaller than adhesion between the back sheet and the electrolyte membrane material, and adhesion between the reinforcing member and the electrolyte membrane material.

3. The manufacturing method of the reinforced electrolyte membrane, according to claim 2, wherein:
the electrolyte membrane material is made of a perfluoroalkyl sulfonic acid precursor;
the back sheet is made of perfluoroalkoxy alkane; and
the reinforcing member is made of stretched polytetrafluoroethylene.

4. A manufacturing apparatus of a reinforced electrolyte membrane, the manufacturing apparatus comprising:
an electrolyte-membrane manufacturing apparatus configured to manufacture a belt-shaped electrolyte membrane material including a back sheet on one surface thereof; and
a reinforcing-member manufacturing apparatus configured to place a belt-shaped reinforcing member on the other surface of the belt-shaped electrolyte membrane material including the back sheet which other surface is an opposite side to the back sheet, so as to attach the reinforcing member to the electrolyte membrane material.
